(19) United States
(12) Patent Application Publication
(10) Pub. No.: US 2008/0088580 A1
(43) Pub. Date: Apr. 17, 2008

(54) Information Input and Output Device, Information Processing Method, and Computer Program

(76) Inventors: Ivan Poupyrev, Tokyo (JP); Henry Owen Newton-Dunn, Tokyo (JP); Olivier Bau, Orsay Cedex (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/736,976

(22) Filed: Apr. 18, 2007

(30) Foreign Application Priority Data
Apr. 19, 2006 (JP) P2006-115349

(51) Int. Cl. G09G 5/00

(52) U.S. Cl. 345/156

(57) ABSTRACT

An information input and output device having a polyhedral shape includes plural display units set on respective sides forming a polyhedron, a sensor that detects the rotation or the tilt of the information input and output device, and a control unit that detects user input based on user operation of the information input and output device and executes update of displayed information on the display units and output of control information through a communicating unit.

### CROSS-REFERENCES TO RELATED APPLICATIONS

The present invention contains subject matter related to Japanese Patent Application JP 2006-115349 filed in the Japanese Patent Office on Apr. 19, 2006, the entire contents of which being incorporated herein by reference.

### BACKGROUND OF THE INVENTION

1. Field of the Invention

The present invention relates to an information input and output device, an information processing method, and a computer program. More particularly, the present invention relates to an information input and output device, an information processing method, and a computer program for performing information display and information input applicable to control of external apparatuses such as a personal computer (PC).

2. Description of the Related Art

A keyboard, a mouse, or the like is used for inputting information to an information processing apparatus such as a personal computer (PC). A two-dimensional display such as an LCD or a CRT is used for displaying output data from the information processing apparatus such as a PC. However, in the two-dimensional display, since an area used for data display is defined as a rectangular area, processing for scrolling display data not shown in a display area by, for example, operating the mouse is necessary.

For example, when selection of a function is executed using menus in operation in which an input device is used, processing for displaying menus screen showing information on plural functions on a display of the PC, moving a cursor to a specific function display position in the menus, and clicking the cursor is executed. However, in such operation, a display area for the menus is limited by an area of the display. In order to display a large number of functions, it is necessary to execute new processing such as screen scroll.

A display device of a multi-display type with display units set on respective sides of a stereoscopic shape is described in, for example, JP-A-8-241069, JP-A-2005-3732, and JP-A-2004-62267. In such a display device of the multi-display type, compared with the two-dimensional display, it is possible to increase information that can be provided to a user.

However, these related arts disclose a structure in which the display units are set on plural sides. An input switch is also described in JP-A-2004-62267. However, in all the related arts, a function for effectively utilizing a polygon as an input and output device for information and remarkably improving operability for a user is not provided.

### SUMMARY OF THE INVENTION

Therefore, it is desirable to provide an information input and output device, an information processing method, and a computer program that make it possible to set display units on respective sides of a polyhedron having a stereoscopic shape, perform user input efficiently and with high operability, and execute presentation of various kinds of information and input of information by a user under high user operability.

According to an embodiment of the invention, there is provided an information input and output device having a polyhedral shape, including plural display units set on respective sides forming a polyhedron, a sensor that detects the rotation or the tilt of the information input and output device, and a control unit that detects user input based on user operation of the information input and output device and executes update of displayed information on the display units and output of control information through a communicating unit.

In the information input and output device of an embodiment of the invention, the display units are formed as input and output units having a function of an input unit with which user input is possible. The control unit detects the user input through the input and output units and executes update of the displayed information on the display units and the output of the control information through the communicating unit.

In the information input and output device of an embodiment of the invention, the control unit is inputted with information on the rotation or the tilt based on the user operation of the information input and output device from the sensor, identifies sensor detection information as a user input, and executes the update of the displayed information on the display units and the output of the control information through the communicating unit.

In the information input and output device of an embodiment of the invention, the control unit selects a display area, in which information display is executed, out of the plural display units set on the respective sides forming the polyhedron and executes guide display that makes it possible to identify the selected display area.

In the information input and output device of an embodiment of the invention, the control unit sets a display area, in which information display is executed, out of the plural display units set on the respective sides forming the polyhedron in a form of a belt-shaped area formed by plural sides or an adjacent area formed by plural sides adjacent to one another.

In the information input and output device of an embodiment of the invention, the control unit displays, on the display units, selection menus for selecting an external apparatus that can be set as a control object apparatus, function selection menus for selecting a function of the external apparatus, or operation information and executes update processing for the displayed information on the basis of user operation.

In the information input and output device of an embodiment of the invention, the control unit analyzes, on the basis of detection information of the sensor, which of the plural display units is located on an uppermost side and executes processing for selecting, as an information display area, the display unit located on the uppermost side or the plural display units including a neighborhood of the display unit.

According to another embodiment of the invention, there is provided an information processing method in an information input and output device having a polyhedral shape and having plural display units set on respective sides forming a polyhedron, the information processing method including a state detecting step of detecting, in a sensor, the rotation or the tilt of the information input and output device, a user input detecting step of detecting, in a control unit, a user input based on user operation of the information input and output device, and a control step of executing, in the control unit, update of displayed information on the display units and output of control information through a communicating unit.

In the information processing method of an embodiment of the invention, the display units are formed as input and output units having a function of an input unit with which user input is possible. The user input detecting step is a step of detecting the user input through the input and output units and the control step is a step of executing update of the displayed information on the display units and the output of the control information through the communicating unit on the basis of the user input through the input and output units.

In the information processing method of an embodiment of the invention, the user input detecting step is a step of being inputted with information on the rotation or the tilt based on the user operation of the information input and output device from the sensor and identifying sensor detection information as a user input and the control step is a step of executing the update of the displayed information on the display units and executing the output of the control information through the communicating unit on the basis of the sensor detection information.

In the information processing method of an embodiment of the invention, the control step includes a step of selecting a display area, in which information display is executed, out of the plural display units set on the respective sides forming the polyhedron and executing guide display that makes it possible to identify the selected display area.

In the information processing method of an embodiment of the invention, the control step includes a step of setting a display area, in which information display is executed, out of the plural display units set on the respective sides forming the polyhedron in a form of a belt-shaped area formed by plural sides or an adjacent area formed by plural sides adjacent to one another.

In the information processing method, the control step includes a step of displaying, on the display units, selection menus for selecting an external apparatus that can be set as a control object apparatus, function selection menus for selecting a function of the external apparatus, or operation information and executing update processing for the displayed information on the basis of user operation.

In the information processing method, the control step includes a step of analyzing, on the basis of detection information of the sensor, which of the plural display units is located on an uppermost side and executing processing for selecting, as an information display area, the display unit located on the uppermost side or the plural display units including a neighborhood of the display unit.

According to still another embodiment of the invention, there is provided a computer program for causing a computer to execute information processing in an information input and output device having a polyhedral shape and having plural display units set on respective sides forming a polyhedron, the computer program causing the computer to execute a state detecting step of detecting, in a sensor, the rotation or the tilt of the information input and output device, a user input detecting step of detecting, in a control unit, a user input based on user operation of the information input and output device, and a control step of executing, in the control unit, update of displayed information on the display units and output of control information through a communicating unit.

The computer program according to an embodiment of the invention is a computer program that can be provided to, for example, a computer system capable of executing various program codes through a storage medium provided in a computer readable format, a communication medium, recording media such as a CD, an FD, and an MO, or a communication medium such as a network. By providing such a program in a computer readable format, processing corresponding to the program is realized on the computer system.

Other objects, characteristics, and advantages of the invention will be apparent through more detailed explanations based on embodiments of the invention described later and attached drawings. In this specification, a system is a logical set of plural apparatuses and is not limited to apparatuses of various structures housed in an identical housing.

According to an embodiments of the invention, in the information input and output device, the display units are set on the respective sides of the polyhedron and update of information display and output of control information are executed on the basis of information on the rotation and the tilt of the information input and output device inputted from the sensor and user input to the input and output units. According to this constitution, it is possible to sequentially update displayed information on the respective sides according to operation, for example, the rotation of the information input and output device, information display of an unlimited number of menus and the like is realized, and it is possible to perform various kinds of information display different from that on the two-dimensional display. In executing information input processing and control processing for an external apparatus, a user is capable of inputting various kinds of selection information and operation information by touching respective display surfaces or rotating or tilting the information input and output device itself. Thus, it is possible to apply various kinds of control to various apparatuses.

### BRIEF DESCRIPTION OF THE DRAWINGS

FIG. 1 is a diagram for explaining an external structure of an information input and output device according to an embodiment of the invention;

FIG. 2 is a diagram for explaining an example of processing to which the information input and output device is applied;

FIG. 3 is a diagram for explaining an example of processing to which the information input and output device is applied;

FIG. 4 is a diagram for explaining an example of processing to which the information input and output device is applied;

FIG. 5 is a diagram for explaining an example of a structure of the information input and output device;

FIG. 6 is a diagram for explaining an example of processing to which the information input and output device is applied;

FIG. 7 is a diagram for explaining an example of processing to which the information input and output device is applied;

FIG. 8 is a diagram for explaining an example of processing to which the information input and output device is applied;

FIG. 9 is a diagram for explaining an example of processing to which the information input and output device is applied;

FIG. 10 is a diagram for explaining an example of processing to which the information input and output device is applied;

FIG. 11 is a diagram for explaining an example of processing to which the information input and output device is applied;

FIG. 12 is a flowchart for explaining a sequence in processing to which the information input and output device is applied; and

FIG. 13 is a diagram for explaining an example of a hardware configuration of an information processing apparatus used in an information processing system.

### DESCRIPTION OF THE PREFERRED EMBODIMENTS

Details of an information input and output device, an information processing method, and a computer program according to an embodiment of the invention will be hereinafter explained in detail with reference to the accompanying drawings.

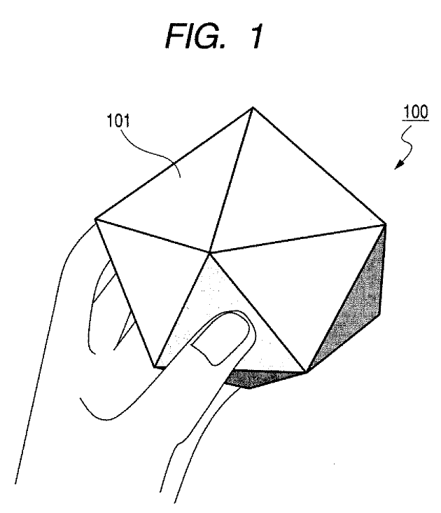

First, an example of a structure of the information input and output device according to the embodiment will be explained with reference to FIG. 1. An information input and output device 100 shown in FIG. 1 has a stereoscopic shape of a regular icosahedron. Respective sides forming the information input and output device 100 function as display units and input units. For example, the sides are capable of performing display using a liquid crystal display (LCD), an organic EL, a light-emitting diode (LED), or the like. Input units of a touch panel form or an operation button form are formed on the respective sides. As an example, a structure in which input and output units 101 formed by liquid crystal displays of the touch panel form are set on the respective sides of the information input and output device 100 will be explained.

In this embodiment, the information input and output device 100 of the regular icosahedron is explained as an example. However, any stereoscopic shape of a polyhedron may be adopted and the number of sides of the polyhedron is arbitrary. As described later, an acceleration sensor (gyro) is built in the information input and output device 100. For example, it is also possible to input information by rotating or tilting the information input and output device 100.

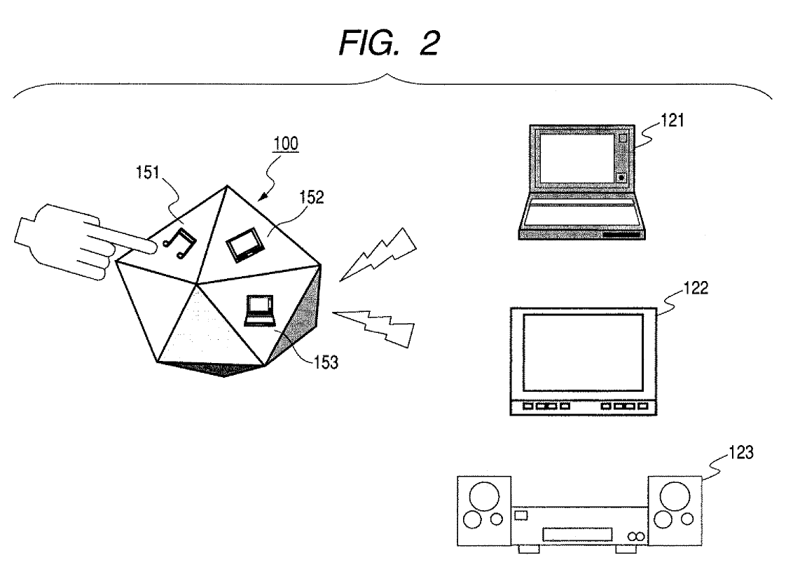

An example of use of the information input and output device 100 will be explained with reference to FIG. 2. Various data are displayed on the input and output units 101 on the sides forming the information input and output device 100. For example, according to the display of a menu screen, it is possible to perform, for example, selection of a control object apparatus and selection of a function after the selection of the control object apparatus. Moreover, operation after the selection of the function is possible.

The information input and output device 100 has a communicating unit and is capable of communicating with other information processing devices and electronic devices. The information input and output device 100 is capable of communicating with, for example, a PC 121, a television 122, and an audio player 123. For example, it is possible to execute control of these apparatuses according to operation of the information input and output device 100.

Specifically, for example, as shown in FIG. 2, first, icons of control object apparatuses are displayed on input and output units 151 to 153 of the respective sides forming the information input and output device 100. In the example in FIG. 2, an icon indicating music play corresponding to the audio player 123 is displayed on the input and output unit 151, an icon corresponding to the television 122 is displayed on the input and output unit 152, and an icon corresponding to the PC 121 is displayed on the input and output unit 153.

When a user touches any one of the input and output units 151 to 153 on which the icons are displayed, an input signal from an input unit serving as a touch sensor formed on each of the sides is inputted to a control unit of the information input and output device 100. For example, when the user selects the icon indicating music play corresponding to the audio player 123, the control unit of the information input and output device 100 performs control for displaying selection menus for functions of the audio player 123 on the input and output units of the respective sides forming the information input and output device 100.

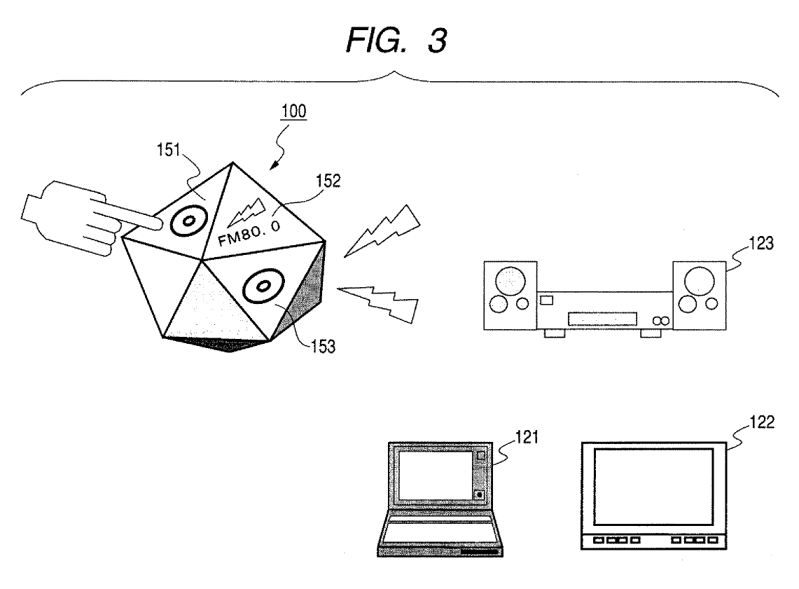

Specifically, for example, display shown in FIG. 3 is performed. In the example of display in FIG. 3, a selection screen for a CD or the like playable by the audio player 123 is displayed on the input and output units 151 and 153 and a broadcasting station selection screen by a tuner provided in the audio player 123 is presented on the input and output unit 152. When the user touches any one of the input and output units 151 to 153, an input signal from the input unit serving as the touch sensor formed on each of the sides is inputted to the control unit of the information input and output device 100. For example, when the user selects an icon indicating CD play, the control unit of the information input and output device 100 transmits a reproduction request for information in the CD selected to the audio player 123 via the communicating unit. The audio player 123 starts play of the CD in response to this request.

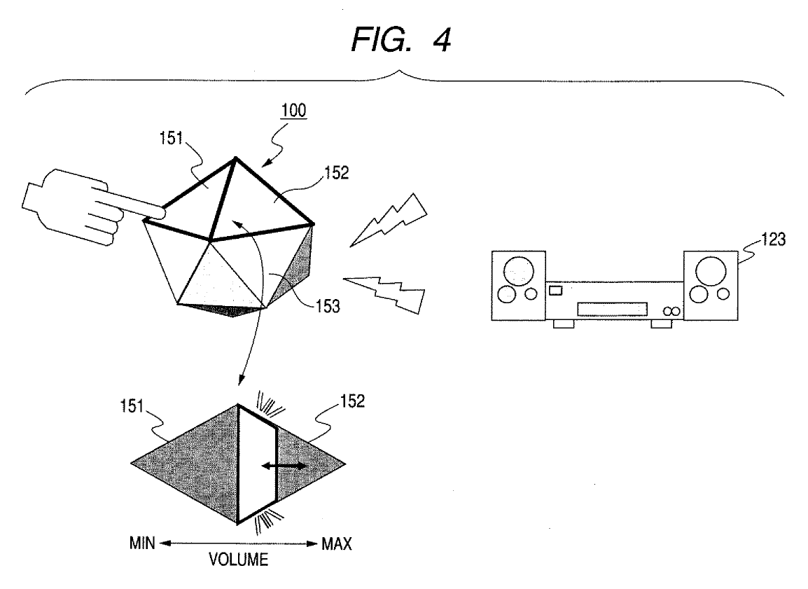

The control unit of the information input and output device 100 performs control for displaying display for controlling the audio player 123 on the input and output units of the respective sides forming the information input and output device 100. For example, as shown in FIG. 4, the control unit executes display for volume control by applying the input and output units 151 and 152 to the display.

The user is capable of performing volume control by touching the input and output units 151 and 152. When the user touches any one of the input and output units 151 and 152, an input signal from the input unit serving as the touch sensor formed on each of the sides is inputted to the control unit of the information input and output device 100. The control unit of the information input and output device 100 transmits a volume control request based on input information to the audio player 123 via the communicating unit. The audio player 123 executes the volume control in response to this request.

As described above, the acceleration sensor (gyro) is built in the information input and output device 100. The user is capable of, for example, operating an external apparatus or updating displayed information on the basis of tilt information of the information input and output device 100 without touching the input and output units 151 and 152. In the example shown in FIG. 4, when the user rotates (tilts) the information input and output device 100 to, for example, the input and output unit 152 side, the control unit of the information input and output device 100 detects, on the basis of tilt information from the acceleration sensor (gyro), that the information input and output device 100 has rotated to the input and output unit 152 side. The control unit transmits, on the basis of this detection information, a request for turning up the volume to the audio player 123 via the communicating unit. On the other hand, when the user rotates (tilts) the information input and output device 100 to the input and output unit 151 side, the control unit of the information input and output device 100 detects, on the basis of tilt information from the acceleration sensor (gyro), that the information input and output device 100 has rotated to the input and output unit 151 side. The control unit transmits, on the basis of this detection information, a request for turning down the volume to the audio player 123 via the communicating unit.

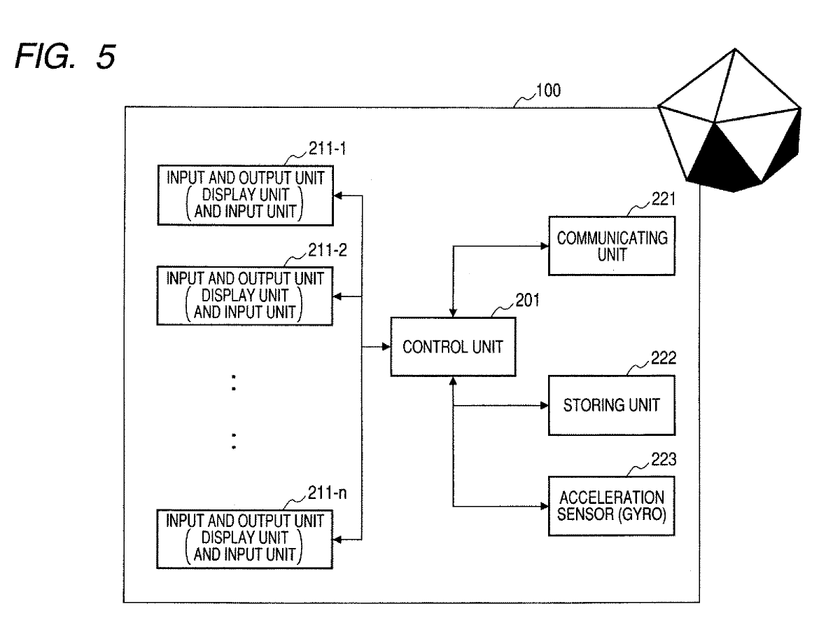

An example of a structure of the information input and output device 100 according to the embodiment will be explained with reference to FIG. 5. As shown in FIG. 5, the information input and output device 100 according to the embodiment has a control unit 201, plural (n) input and output units 211-1 to 211-n set on respective sides of a polyhedron, a communicating unit 221, a storing unit 222, and an acceleration sensor (gyro) 223.

The control unit 201 is a microcomputer having a CPU and the like. The control unit 201 executes various kinds of data processing in accordance with programs stored in the storing unit 222. The input and output units 211-1 to 211-n are plural (n) input and output units set on the respective sides of the polyhedron. As described above, the input and output units 211-1 to 211-n are formed by liquid crystal displays having touch sensors. The storing unit 222 is used as a storing unit such as a storage area for various data processing programs and a work area applied to data processing in the control unit 201. The storing unit 222 is formed by a RAM, a ROM, an HDD, or the like.

The acceleration sensor (gyro) 223 detects accelerations corresponding to three orthogonal axes, i.e., an X axis, a Y axis, and a Z axis, respectively and inputs detection data to the control unit 201. The control unit 201 discriminates, on the basis of the input from the acceleration sensor (gyro) 223, for example, which of the input and output units 211-1 to 211-n forming the polyhedron is located on an uppermost side. The control unit 201 displays operation information of the user on the input and output unit located on the uppermost side and performs setting for allowing the user to perform input. Alternatively, the control unit 201 performs display of the menu information and the operation information explained above with reference to FIGS. 2 to 4 on plural sides including the input and output unit located on the uppermost side. When user input is performed from these input and output units, the control unit 201 receives input information and performs necessary processing, for example, update of the displayed information and output of control information to an external apparatus.

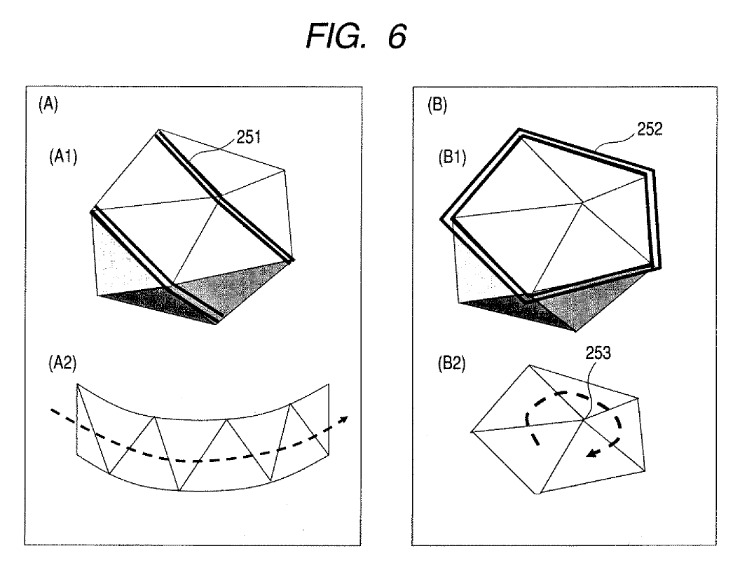

Plural examples of use of the information input and output device 100 according to the embodiment will be explained with reference to FIG. 6 and the subsequent figures. (A) in FIG. 6 is a form in which information display is executed by applying one belt-shaped line of a polyhedron thereto. This example of display corresponds to the example of display explained with reference to FIGS. 2 and 3.

When such a belt-shaped display area is used, a belt-shaped line defined by a double line 251 shown in a polygon in (A1) is defined as an information display area. For example, menus for apparatus selection or function selection or operation information is displayed on these input and output units.

When such display processing is performed, as shown in (A2) in FIG. 6, the surface of the polygon are revolved. The user holds the information input and output device 100 with a hand and rotates the information input and output device 100 to observe displayed information on sides forming the respective input and output units. In this case, the input information of the acceleration sensor 223 explained with reference to FIG. 5 is inputted to the control unit 201. The control unit 201 changes the displayed information according to a rotation state. For example, when eight surfaces are formed over the surface of the polygon, it is possible to display eight kinds of icons at a time. When it is detected that the information input and output device 100 is rotated to revolve once by operation of the user, the control unit 201 executes update processing for the displayed information. According to this displayed information update processing, it is possible to display different data on the same input and output unit every time the information input and output device 100 is rotated. As a result, it is possible to execute unlimited different kinds of information display.

(B) in FIG. 6 is a form in which information display is executed by applying plural adjacent sides set on a polyhedron thereto. In this example of display, five sides are used as display areas. A pentagonal area including five sides forming input and output units defined by a double line 252 shown in a polygon in (B1) is selected as an information display area. For example, menus for apparatus selection or function selection or operation information is displayed on these input and output units. As shown in (B2) in FIG. 6, five display surfaces are used as display areas for information.

In this example of display, as in the example described above, for example, when the information input and output device 100 is rotated according to operation by the user with a center point 253 shown in (B2) in FIG. 6 as a center axis and it is detected that the information input and output device 100 has revolved once, the control unit 201 is capable of executing update processing for the displayed information. According to this displayed information update processing, it is possible to display different data on the same input and output unit every time the polygon is rotated. As a result, it is possible to execute unlimited different kinds of information display.

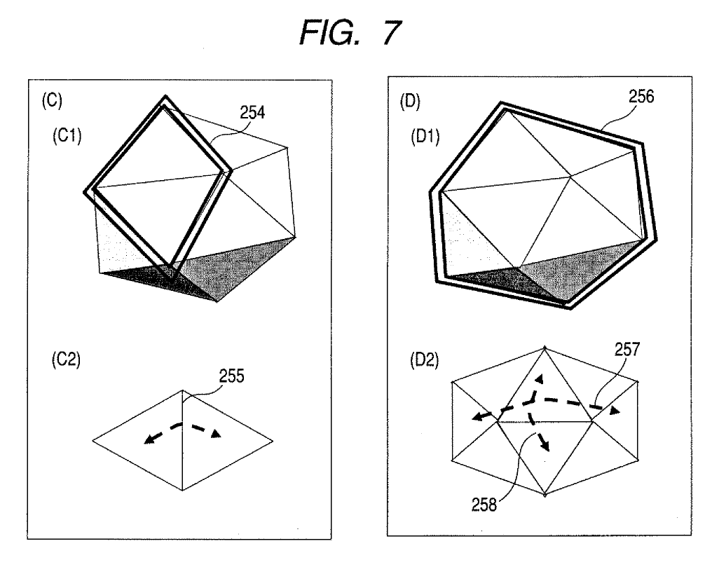

(C) in FIG. 7 is a form in which information display is executed by applying two adjacent sides set on a polyhedron thereto. This example of display corresponds to the example of display explained above with reference to FIG. 4. A diamond-shaped area including two surfaces forming input and output units defined by a double line 254 shown in a polygon in (C1) is selected as an information display area. For example, volume operation information is displayed on these input and output units. In this structure, menus for apparatus selection or function selection or the like may be displayed. As shown in (C2) in FIG. 7, two display surfaces are used as display areas for information.

For example, when operation information display for volume adjustment is executed, as described above, the user can perform volume operation by touching or rotating (tilting) the input and output units.

In this example of display, as in the example described above, for example, by repeating processing for tilting the information input and output device 100 to the left and the right according to operation by the user with a center line 255 shown in (C2) in FIG. 7 as a center axis, the control unit 201 is capable of executing update processing for displayed information. According to this displayed information update processing, it is possible to display different data on the same input and output unit by repeating the tilt. As a result, it is possible to execute unlimited different kinds of information display.

(D) in FIG. 7 is a form in which information display is executed by applying plural adjacent sides set on a polyhedron thereto. In this example of display, eight sides are used as display areas. An area of a polygon including eight surfaces forming input and output units defined by a double line 256 shown in a polygon in (D1) is selected as an information display area. For example, menus for apparatus selection or function selection or operation information is displayed on these input and output units. As shown in (D2) in FIG. 7, eight display surfaces are used as display areas for information.

For example, as a specific example of operation processing, it is possible to apply the operation processing to operation for moving a cursor displayed on a PC. When the information input and output device 100 is rotated (tilted) in a direction of an arrow 257 shown in (D2) in FIG. 7, it is possible to apply the operation processing to processing for moving the cursor to the left and the right. When the information input and output device 100 is rotated (tilted) in a direction of an arrow 258, it is possible to apply the operation processing to processing for moving the cursor up and down. As control for an audio player, when the information input and output device 100 is rotated (tilted) in the direction of the arrow 257, it is possible to apply the operation processing to processing for executing adjustment of volume. When the information input and output device 100 is rotated (tilted) in the direction of the arrow 258, it is possible to apply the operation processing to processing for adjusting a sound quality, for example, adjusting balance of a high tone and a low tone.

In this way, the control unit 201 shown in FIG. 5 changes the control to be executed according to the information displayed on the input and output units 211.

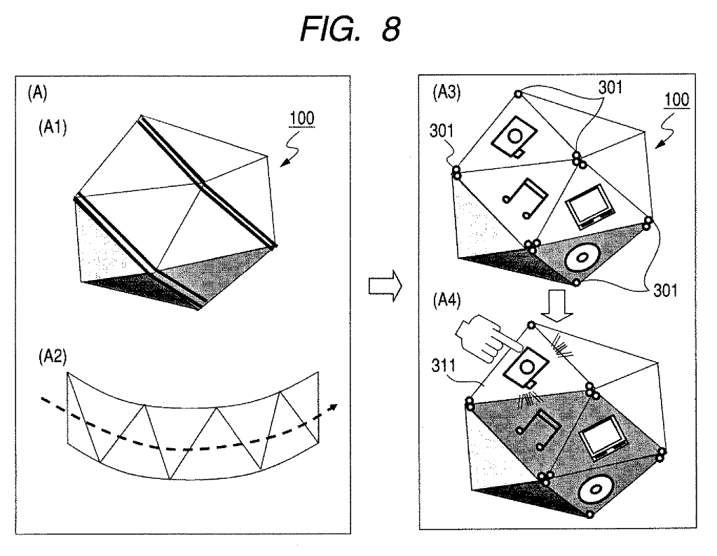

FIG. 8 shows an example of specific display and operation processing in executing information display by applying the belt-shaped line explained with reference to (A) in FIG. 6 thereto. (A1) and (A2) in FIG. 8 are diagrams same as those explained with reference to (A) in FIG. 6. A belt-shaped line defined by a double line shown in a polygon in (A1) is selected as an information display area.

(A3) in FIG. 8 shows a specific example of display. In the belt-shaped display area set on the information input and output device 100, guide indicators 301 for making it possible to identify the area are displayed. For example, the guide indicators 301 that emit light in a specific color are displayed in order to make it possible to identify the belt-shaped display area set on the information input and output device 100. The user can rotate the information input and output device 100 in accordance with the guide indicators 301.

In the example shown in (A3) in FIG. 8, as explained above with reference to FIG. 2, respective icons set for menus corresponding to a control object apparatus, a control object program, or the like are displayed in respective display areas of the respective sides forming the information input and output device 100. When it is assumed that the respective icons shown in (A3) in FIG. 8 are selection menus for programs executed in a PC, an icon of a camera is an icon for designating execution of display and edition processing for camera photographing data stored in the PC. An icon indicating music play corresponds to an icon applied to start of a program for causing the PC to execute music play. An icon of a television corresponds to an icon applied to start of a program for causing the PC with a tuner to execute processing for watching a television.

When the user designates execution of the display and edition processing for the camera photographing data stored in the PC, as shown in (A4) in FIG. 8, the user touches the input and output unit 311 in which the camera icon is displayed. According to this processing, input information is inputted to the control unit (the control unit 201 explained with reference to FIG. 5) of the information input and output device 100. The control unit 201 outputs request data including a command for starting an execution program for the display and edition processing for the camera photographing data to a control object apparatus (in this case, the PC) via the communicating unit 221. According to this processing, the PC as the control object apparatus starts the execution program for the display and edition processing for the camera photographing data. In order to clearly indicate to the user that a specific icon is selected, display control for, for example, brightening only display of the input and output unit corresponding to a user selected area, flashing the display, or changing a display color of the input and output unit may be performed as shown in (A4) in FIG. 8.

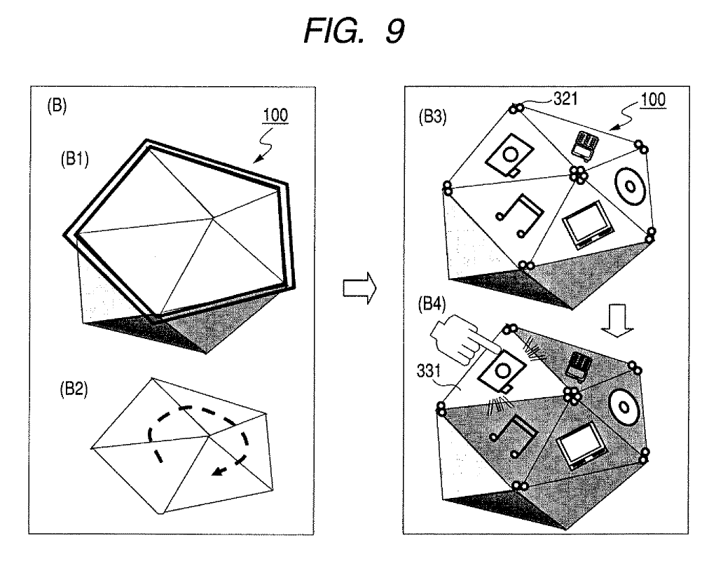

FIG. 9 shows a specific example of display and operation processing in executing information display by applying the pentagonal display area explained with reference to (B) in FIG. 6 thereto. (B1) and (B2) in FIG. 9 are diagrams same as those explained with reference to (B) in FIG. 6. Five input and output units defined by a double line shown in a pentagonal area in (B1) are selected as information display areas.

(B3) in FIG. 9 shows a specific example of display. In the five display areas set on the information input and output device 100, guide indicators 321 for making it possible to identify the areas are displayed. For example, the guide indicators 321 that emit light in a specific color are displayed in order to make it possible to identify the pentagonal display area set on the information input and output device 100. The user can operate, for example, rotate the information input and output device 100 in accordance with the guide indicators 321.

In the example shown in (B3) in FIG. 9, as explained with reference to FIG. 8, respective icons set for menus corresponding to a control object apparatus, a control object program, or the like are displayed in respective five input and output units included in the pentagonal display area of the information input and output device 100. As explained with reference to FIG. 8, it is assumed that these are, for example, selection menus for programs executed in a PC. When the user designates execution of display and edition processing for camera photographing data stored in the PC, as shown in (B4) in FIG. 9, the user touches the input and output unit 331 in which a camera icon is displayed. According to this processing, input information is inputted to the control unit (the control unit 201 explained with reference to FIG. 5) of the information input and output device 100. The control unit 201 outputs request data including a command for starting an execution program for the display and edition processing for the camera photographing data to a control object apparatus (in this case, the PC) via the communicating unit 221.

According to this processing, the PC as the control object apparatus starts the execution program for the display and edition processing for the camera photographing data. In order to clearly indicate to the user that a specific icon is selected, display control for, for example, brightening only display of the input and output unit corresponding to a user selected area, flashing the display, or changing a display color of the input and output unit may be performed as shown in (B4) in FIG. 9.

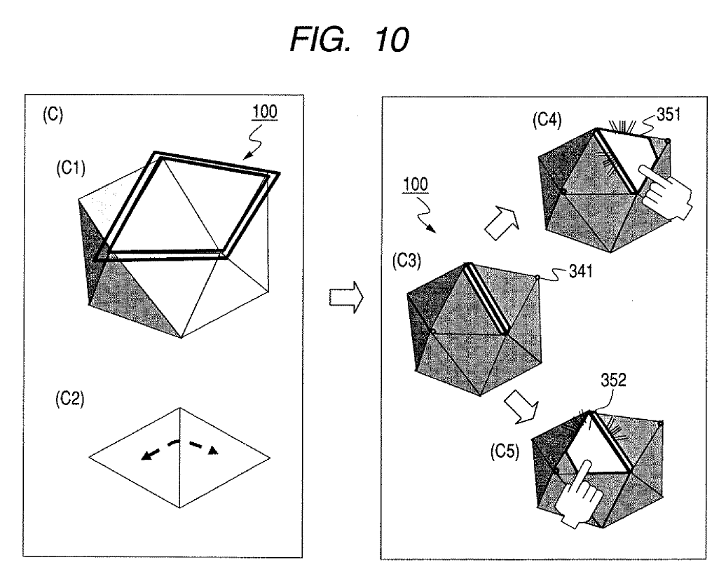

FIG. 10 shows a specific example of display and operation processing in executing information display by applying the diamond-shaped display area explained with reference to (C) in FIG. 7 thereto. (C1) and (C2) in FIG. 10 are diagrams same as those explained with reference to (C) in FIG. 7. Two input and output units defined by a double line shown in a diamond-shaped area in (C1) are selected as information display areas.

(C3) in FIG. 10 shows a specific example of display. In two display areas set in the information input and output device 100, guide indicators 341 for making it possible to identify the area are displayed. For example, the guide indicators 341 that emit light in a specific color are displayed to make it possible to identify the diamond-shaped display area set on the information input and output device 100. The user can operate, for example, rotate the information input and output device 100 in accordance with the guide indicators 341.

In the example shown in FIG. 10, it is possible to use this setting of the display area for, for example, the volume adjustment for the audio player explained above with reference to FIG. 4, luminance adjustment for a screen of a television, or the like. For example, as shown in (C4) in FIG. 10, when the user touches one input and output unit 351 side included in the diamond-shaped display area, it is possible to perform control for turning up the volume or setting luminance high.

On the other hand, as shown in (C5) in FIG. 10, when the user touches an input and output unit 352 on the opposite side included in the diamond-shaped display area, it is possible to perform control for, for example, turning down the volume or setting luminance low. In the display in the respective input and output units, display control for displaying an indicator corresponding to a degree of adjustment is executed. This display control is performed on the basis of control by the control unit.

Input information from these input and output units is inputted to the control unit (the control unit 201 explained with reference to FIG. 5) of the information input and output device 100. The control unit 201 outputs volume adjustment and luminance adjustment request data to a control object apparatus via the communicating unit 221. According to this processing, volume adjustment and luminance adjustment processing is executed in the control object apparatus.

As described above, the acceleration sensor (gyro) is built in the information input and output device 100. Without the user touching the input and output units, it is possible to input tilt information of the information input and output device 100 to the control unit, determine a control form based on tilt, a rotating direction, and an angle in the control unit, and output a control signal to an external apparatus on the basis of the control form determined.

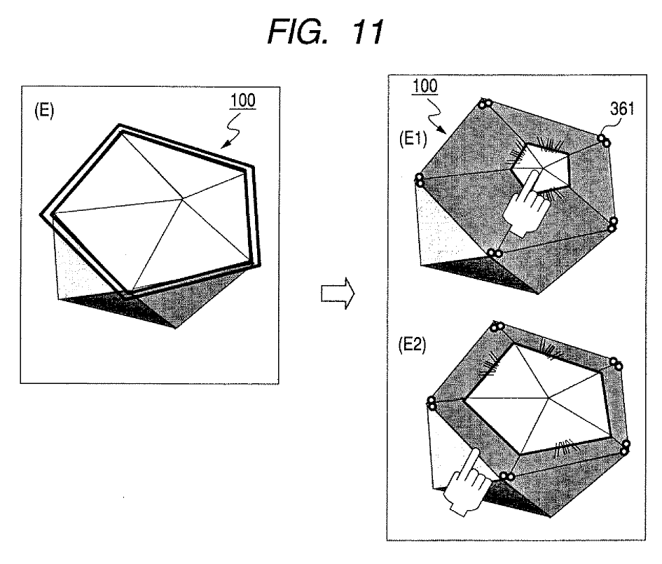

FIG. 11 is an example of use in which a display area including five input and output units is applied to, rather than menu display, adjustment control such as volume control same as that in the diamond-shaped display area explained with reference to FIG. 10. In the five display areas, guide indicators 361 for making it possible to identify the area are displayed. For example, the guide indicators 361 that emit light in a specific color are displayed to make it possible to identify a pentagonal display area set on the information input and output device 100.

For example, as shown in (E1) in FIG. 11, when the user touches the center of the pentagonal display area, control for outputting a control signal for turning down the volume and reducing a size of the indicators displayed in the pentagonal display area is executed in the control unit. As shown in (E2) in FIG. 11, when the user touches the end of the pentagonal display area, control for outputting a control signal for turning up the volume and increasing a size of the indicators displayed in the pentagonal display area is executed in the control unit.

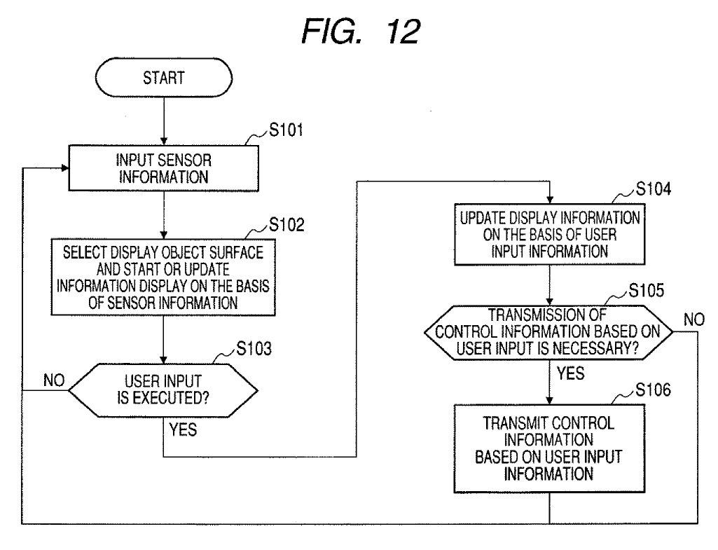

A sequence of processing executed in the control unit of the information input and output device 100 according to the embodiment will be explained with reference to a flowchart shown in FIG. 12. First, in step S101, sensor information from the acceleration sensor (gyro) is inputted to the control unit. The sensor information is periodically inputted to the control unit. In step S102, the control unit selects, on the basis of the sensor information, the display units (the input and output units) set on the respective sides of the polyhedrons and executes display of information.

For example, the control unit determines a display area formed by specific sides such as the belt-like or adjacent area explained above with reference to FIGS. 6 to 11 and executes information display on the display area determined. The control unit executes, for example, processing for analyzing, on the basis of detection information of the sensor, which of the plural display units is located on the uppermost side and selecting, as an information display area, the display unit located on the uppermost side or the plural display units including a neighborhood of the display unit. For example, initial display is a selection screen for a control object apparatus. In this case, the control unit executes guide display for identifying a display area of information. The guide display is, for example, the guide indicators 301 explained above with reference to FIG. 8.

In step S103, the control unit judges presence or absence of a user input. This user input is executed on the basis of detection of operation of the user on the display surfaces as the input and output units or detection of the rotation and the tilt of the information input and output device 100 itself. When a user input is not detected, the control unit proceeds to step S101, sensor information is inputted to the control unit, and the control unit performs display and update processing for the sensor information.

When a user input is detected in step S103, in step S104, the control unit executes update of the displayed information based on the user input. The control unit performs, for example, switching from apparatus selection menus to function selection menus, switching from the function selection menus to display for apparatus control such as volume operation or the like, or, when, for example, the volume operation is performed, update of indicator display.

In step S105, the control unit judges whether transmission of control information to an external apparatus base on the user input is necessary. When the transmission of the control information is necessary, in step S106, the control unit transmits the control information based on the user input to a control object. When it is judged in step S105 that the transmission of the control information to the external apparatus based on the user input is unnecessary or after the control unit transmits the control information in step S106, the control unit returns to step S101 and performs control based on input of sensor information.

In this way, in the information input and output device according to the embodiment, update of information display and output of control information are executed on the basis of rotation and tilt information inputted from the sensor and a user input to the input and output units. Displayed information is sequentially updated according to operation, for example, rotation of the information input and output device. It is possible to display an unlimited number of menus and perform various kinds of information display different from that on the two-dimensional display. In information input, the user is capable of performing various kinds of input and performing various kinds of control on various apparatuses by touching the respective display surfaces or rotating or tilting the information input and output device itself.

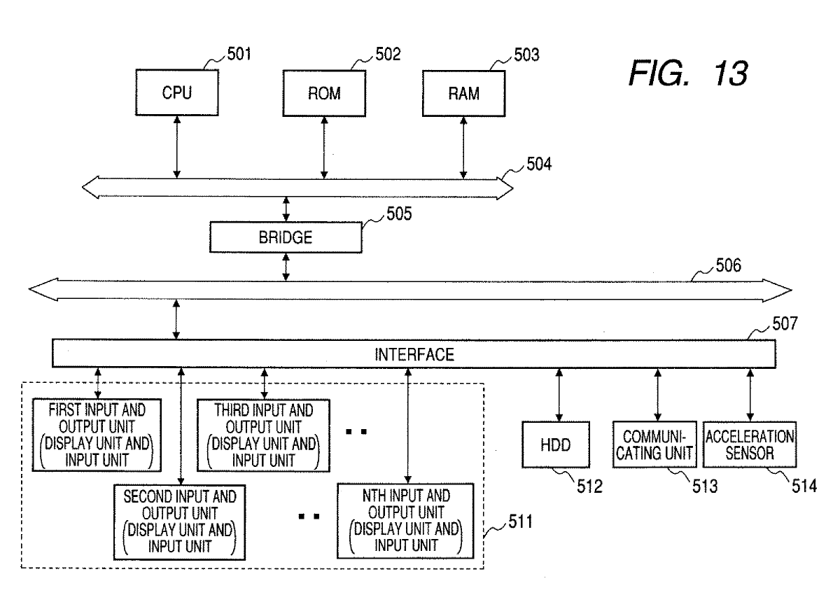

Lastly, an example of a hardware configuration of the information input and output device that executes the processing described above will be explained with reference to FIG. 13. A CPU (Central Processing Unit) 501 is a component of the control unit explained in the embodiment described above. The CPU 501 executes display control for information on the input and output units, update of displayed information based on a user input through the input and output units or detection information of the acceleration sensor (gyro), transmission control for control information, and the like. These kinds of processing are executed in accordance with computer programs stored in, for example, a ROM (Read Only Memory) 502 and a hard disk 512, which are storing units of the information input and output device.

The ROM 502 stores programs, arithmetic operation parameters, and the like used by the CPU 501. A RAM (Random Access Memory) 503 stores programs used in execution by the CPU 501, parameters that change as appropriate in the execution, and the like. These devices are connected to each other by a host bus 504 including a CPU bus. The host bus 504 is connected to a bus 506 via a bridge 505.

An input and output unit 511 includes plural input and output units (first to nth) set on respective sides forming a polyhedron. For example, the input and output unit 511 is constituted by an LCD of a touch panel format and functions as a display unit that executes various kinds of information display and an input unit to which it is possible to input information from the user. An HDD (Hard Disk Drive) 512 has a hard disk built therein. The HDD 512 drives the hard disk and causes the hard disk to record or reproduce programs executed by the CPU 501 and information. In the hard disk, for example, various computer programs such as a data processing program are stored.

A communicating unit 515 is applied to, for example, transmission of control information to an external apparatus as a control object apparatus. An acceleration sensor 514 detects the rotation and the tilt of three axes X, Y, and Z and inputs a detection value to the CPU 501 as a control unit. The example of the hardware configuration of the information input and output device shown in FIG. 13 is only an example. The information input and output device according to the embodiment of the invention is not limited to the structure shown in FIG. 13. It is also possible to set other functions in the information input and output device as long as it is possible to execute the processing explained in the embodiment. The hard disk and the like do not have to be provided. Various modifications of the embodiment are possible. For example, a flash memory or the like may be mounted.

It is possible to execute the series of processing explained in this specification with hardware, software, or a combination of the hardware and the software. When the processing by the software is executed, it is possible to install a program having a processing sequence recorded therein in a memory in a computer built in dedicated hardware and execute the program. Alternatively, it is possible to install the program in a general-purpose computer capable of executing various kinds of processing and execute the program.

For example, it is possible to record the program in a hard disk or a ROM (Read Only Memory) as a recording medium in advance. Alternatively, it is possible to temporarily or permanently store (record) the program in a removable recording medium such as a flexible disk, a CD-ROM (Compact Disc Read Only Memory), an MO (Magneto Optical) disk, a DVD (Digital Versatile Disk), a magnetic disk, or a semiconductor memory. It is possible to provide such a removable recording medium as so-called package software.

Other than installing the program in a computer from the removable recording medium, it is possible to transfer the program to the computer by radio or transfer the program to the computer via a network such as a LAN (Local Area Network) or the Internet by wire from a download site. The computer can receive the program transferred in that way and install the program in a recording medium such as a hard disk built therein.

The various kinds of processing described in this specification are not only executed in time series in accordance with the above description but may be executed in parallel or individually according to a processing ability of an apparatus that executes the processing or when necessary. In this specification, the system is a logical set of plural apparatuses and is not limited to apparatuses of various structures housed in an identical housing.

As explained above, according to the constitution according to the embodiment, in the information input and output device, the display units are set in the respective sides forming the polyhedron. Update of information display and output of control information are executed on the basis of information on rotation and tilt inputted from the sensor and a user input to the input and output units. According to the constitution, it is possible to sequentially update displayed information on the respective sides according to operation, for example, rotation of the information input and output device, display of information such as an unlimited number of menus is realized, and it is possible to perform various kinds of information display different from that on the two-dimensional display. Even when information input processing and control processing for an external apparatus is executed, the user is capable of inputting various kinds of selection information and operation information by touching the respective display surfaces and rotating or tilting the information input and output device itself. It is possible to apply various kinds of control to various apparatuses.

It should be understood by those skilled in the art that various modifications, combinations, sub-combinations, and alterations may occur depending on design requirements and other factors insofar as they are within the scope of the appended claims or the equivalents thereof.

What is claimed is:

1. An information input and output device having a polyhedral shape, comprising:
plural display units set on respective sides forming a polyhedron;
a sensor that detects rotation or tilt of the information input and output device; and
a control unit that detects user input based on user operation of the information input and output device and executes update of displayed information on the display units and output of control information through a communicating unit.

2. An information input and output device according to claim 1, wherein
the display units are formed as input and output units having a function of an input unit with which user input is possible, and
the control unit detects the user input through the input and output units and executes update of the displayed information on the display units and the output of the control information through the communicating unit.

3. An information input and output device according to claim 1, wherein the control unit is inputted with information on the rotation or the tilt based on the user operation of the information input and output device from the sensor, identifies sensor detection information as a user input, and executes the update of the displayed information on the display units and the output of the control information through the communicating unit.

4. An information input and output device according to claim 1, wherein the control unit selects a display area, in which information display is executed, out of the plural display units set on the respective sides forming the polyhedron and executes guide display that makes it possible to identify the selected display area.

5. An information input and output device according to claim 1, wherein the control unit sets a display area, in which information display is executed, out of the plural display units set on the respective sides forming the polyhedron in a form of a belt-shaped area formed by plural sides or an adjacent area formed by plural sides adjacent to one another.

6. An information input and output device according to claim 1, wherein the control unit displays, on the display units, selection menus for selecting an external apparatus that can be set as a control object apparatus, function selection menus for selecting a function of the external apparatus, or operation information and executes update processing for the displayed information on the basis of user operation.

7. An information input and output device according to claim 1, wherein the control unit analyzes, on the basis of detection information of the sensor, which of the plural display units is located on an uppermost side and executes processing for selecting, as an information display area, the display unit located on the uppermost side or the plural display units including a neighborhood of the display unit.

8. An information processing method in an information input and output device having a polyhedral shape and having plural display units set on respective sides forming a polyhedron, the information processing method comprising the steps of:
detecting, in a sensor, rotation or tilt of the information input and output device;
detecting, in a control unit, a user input based on user operation of the information input and output device; and
executing, in the control unit, update of displayed information on the display units and output of control information through a communicating unit.

9. An information processing method according to claim 8, wherein
the display units are formed as input and output units having a function of an input unit with which user input is possible,
the step of detecting a user input is a step of detecting the user input through the input and output units, and
the step of executing update of displayed information and output of control information is a step of executing update of the displayed information on the display units and the output of the control information through the communicating unit on the basis of the user input through the input and output units.

10. An information processing method according to claim 8, wherein
the step of detecting a user input is a step of inputting information on the rotation or the tilt based on the user operation of the information input and output device from the sensor and identifying sensor detection information as a user input, and
the step of executing update of displayed information and output of control information is a step of executing the update of the displayed information on the display units and executing the output of the control information through the communicating unit on the basis of the sensor detection information.

11. An information processing method according to claim 8, wherein the step of executing update of displayed information and output of control information includes a step of selecting a display area, in which information display is executed, out of the plural display units set on the respective sides forming the polyhedron and executing guide display that makes it possible to identify the selected display area.

12. An information processing method according to claim 8, wherein the step of executing update of displayed information and output of control information includes a step of setting a display area, in which information display is executed, out of the plural display units set on the respective sides forming the polyhedron in a form of a belt-shaped area formed by plural sides or an adjacent area formed by plural sides adjacent to one another.

13. An information processing method according to claim 8, wherein the step of executing update of displayed information and output of control information includes a step of displaying, on the display units, selection menus for selecting an external apparatus that can be set as a control object apparatus, function selection menus for selecting a function of the external apparatus, or operation information and executing update processing for the displayed information on the basis of user operation.

14. An information processing method according to claim 8, wherein the step of executing update of displayed information and output of control information includes a step of analyzing, on the basis of detection information of the sensor, which of the plural display units is located on an uppermost side and executing processing for selecting, as an information display area, the display unit located on the uppermost side or the plural display units including a neighborhood of the display unit.

15. A computer program for causing a computer to execute information processing in an information input and output device having a polyhedral shape and having plural display units set on respective sides forming a polyhedron, the computer program causing the computer to execute:
a state detecting step of detecting, in a sensor, the rotation or the tilt of the information input and output device;
a user input detecting step of detecting, in a control unit, a user input based on user operation of the information input and output device; and
a control step of executing, in the control unit, update of displayed information on the display units and output of control information through a communicating unit.
